(19) United States
(12) Patent Application Publication
(10) Pub. No.: US 2009/0290141 A1
(43) Pub. Date: Nov. 26, 2009

(54) Matched pairs of gemstones

(76) Inventor: David Friedman, Lawrence, NY (US)

Correspondence Address: Bernard Malina, Malina & Associates, PLLC, 444 Madison Avenue, 17th Floor, New York, NY, 10022, US

(21) Appl. No.: 12/454,058

(22) Filed: May 12, 2009

Related U.S. Application Data
(60) Provisional application No. 61/128,504, filed on May 22, 2008.

(51) Int. Cl. G01N 21/87; A44C 17/00; A44C 17/02; B23P 5/00

(52) U.S. Cl. 356/30; 63/32; 63/26; 29/10

(57) ABSTRACT

A system is provided for certifying two or more gemstones as being a matched pair. The system includes measuring values for at least four physical properties of a multiplicity of gemstones, identifying a first gemstone, a second gemstone, and optionally still further gemstones all being within match tolerances of the respective measured values, and certifying in a single certificate that based on the match tolerances, the gemstones constitute a matched set. Also disclosed is jewelry and a process for creating jewelry based on the certification system.

This application claims priority from U.S. Provisional Application Ser. No. 61/128,504 filed on May 22, 2008.

### BACKGROUND OF THE INVENTION

1. Field of the Invention

The present invention refers to a system for certifying two or more gemstones that constitute and can be marketed as a “matched pair,” a process for creating jewelry based on the certified “matched pair,” and jewelry that contains a certified “matched pair.”

2. The Related Art

It has been found that pairs of diamonds which have similar characteristics and geometric parameters are highly desirable by discriminating purchasers and as a result, command a higher sales price than diamond pairs that lack such matching geometric characteristics and other parameters. Matched diamond pairs are deemed to achieve a high degree of perfection and the promotion of such matched pairs is now expected to become a successful marketing tool.

Currently, the diamond jewelry industry's highest volume generic items are diamond studs. Diamond studs are two or more similar diamonds that, in the opinion of the diamond dealer, constitute “A Pair.” Currently, there are no industry or FTC guidelines which would prevent anyone from claiming that a pair of stones are “matched.”

Presently, every major jewelry retailer certifies the quality of many of the diamonds that they sell. However, such retailers, when they sell a pair of diamond studs, the two stones are separately certified. An object of the present invention is to establish a sounder base of information upon which a consumer can rely upon. Moreover, it is an object of the present invention to enhance the value of jewelry that is created with matched pairs of gemstones.

### SUMMARY OF THE INVENTION

A system for certifying two or more gemstones as being a match in their physical properties is provided including:

measuring values for at least four physical properties of a multiplicity of gemstones;

identifying a first gemstone, a second gemstone, and optionally still further gemstones, all being within match tolerances of the respective measured values;

certifying in a single certificate that based on the match tolerances, the first gemstone, the second gemstone, and the optionally still further gemstones, constitute a matched set.

Further, a process for creating jewelry is provided which includes:

preparing two or more jewelry settings to receive gemstones;

selecting a first gemstone, a second gemstone, and optionally still further gemstones that together are certified in a single certificate as having matched tolerances for respective values of at least four physical properties; and

inserting the first gemstone, the second gemstone, and the optional still further gemstones into the two or more jewelry settings.

Also provided is jewelry that includes at least two matched gemstones, the gemstones being held in settings and the gemstones being certified in a single certificate that the gemstones constitute a matched set.

### DETAILED DESCRIPTION OF THE INVENTION

The present invention is directed to the differentiation of commoditized diamond studs to form a unique item. This is accomplished by analyzing various diamond parameters as discussed below and putting the results of such analysis on a printed certificate which will qualify the two diamonds as a matching pair. By way of example, to qualify as a matching pair, each diamond must have the same color or no more than one shade of color difference. Further, the pair of diamonds must have the same width within a maximum variance of 6%, and they must have the same clarity within one grading classification. These parameters serve as an example of a guide for determining whether a pair of diamonds are “a match.”

The weight, cut and shape of a diamond is a function of various parameters, including, inter alia, diameter, crown angle, crown height, pavilion angle, pavilion depth, culet, table size, total depth, girdle thickness, proportion and symmetry. These parameters may be measured on certain equipment known as the Megascope or Sarin apparatus.

The method of selecting such matching pairs contemplates the use of a computer which retains in its memory database the above-mentioned geometric parameters in a manufacturer's inventory. The computer may thus be programmed to select stones whose above-mentioned geometric parameters substantially match, i.e., within pre-determined tolerances, those of the stones being processed. The computer may be programmed to selectively vary the preset tolerances for such geometric parameters to produce various standards of a match. In other words, stones which fall within a tighter tolerance of the various geometric parameters will command a higher sales price than those falling within a wider tolerance.

The matching measuring equipment, e.g., Megascope, can then print a unique card description and photos of the matching stones together with a legend setting forth the matching parameters.

It is understood that whether the parameters of one stone “match” those of another stone depends on the tolerances established which will define various degrees of “match.”

Another example of the parameters for determination of whether a pair of diamonds or other gemstones constitute a “match” are as follows:
Carat weight: plus or minus 6% of average.
Color: one grade or less.
Clarity: one grade or less, same category.
Table %: plus or minus 6% of average.
Crown height: plus or minus 10% of average.
Average diameter: plus or minus 5%.
Girdle: both polished or bruted.
Culet: 2 grades or less.
Finish: 2 grades or less.
Fluorescence: 2 grades or less.

It is uncommon to have a situation where a pair of diamonds match at every criteria such as those mentioned above. Nevertheless, a pair of diamonds may be deemed to constitute a “match” where they do not meet all the matching criteria. Thus, for example, if a pair of diamonds meets at least four criteria, they may still be deemed to constitute a “match” under the principles of the present invention.

If is further understood three (triplets) or more diamonds may be matched as described above as contemplated by the principles of the present invention as described above.

In accordance with the principles of the above invention, there is provided an independent, reliable and recognized source certifying that the two stones being offered by the jewelry retailer to the customer constitute and are being sold as a match. In this way, the customer who is presented with a certificate from an independent, reliable and recognized source attesting to the fact that the diamonds in question are sold as a match, does not have to rely on the jeweler's representations that the pair of diamonds being offered constitute a match.

What is claimed is:

1. A system for certifying two or more gemstones as being a match in their physical property comprising:
measuring values for at least four physical properties of a multiplicity of gemstones;
identifying a first gemstone, a second gemstone, and optionally still further gemstones, all being within match tolerances of the respective measured values; and
certifying in a single certificate that based on the match tolerances, the first gemstone, the second gemstone, and the optionally still further gemstones, constitute a matched set.

2. The system according to claim 1 wherein the two or more gemstones are selected from the group consisting of diamonds, emeralds, sapphires, zircons and rubies.

3. The system according to claim 1 wherein the two or more gemstones are a pair of diamonds.

4. The system according to claim 1 wherein the at least four physical properties and their match tolerances are selected from the group consisting of carat weight (plus or minus 6% of average), color (one grade or less), clarity (one grade or less, same category), table % (plus or minus 6% of average), crown height (plus or minus 10% of average), average diameter (plus or minus 5%), girdle (both polished or bruted), culet (2 grades or less), finish (2 grades or less), and fluorescence (2 grades or less).

5. The system according to claim 1 wherein the first gemstone, the second gemstone, and the optionally still further gemstones are three gemstones in number.

6. The system according to claim 1 wherein the measuring is performed on a Megascope or Sarin apparatus.

7. The system according to claim 1 wherein the certificate has photos of both first and second gemstones and sets forth the measured values.

8. A process for creating jewelry comprising:
preparing two or more jewelry settings to receive gemstones;
selecting a first gemstone, a second gemstone, and optionally still further gemstones that together are certified in a single certificate as having matched tolerances for respective values of at least four physical properties; and
inserting the first gemstone, the second gemstone, and the optional still further gemstones into the two or more jewelry settings.

9. The process according to claim 8 wherein each of the two or more jewelry settings has two or more prongs to hold each gemstone.

10. The process according to claim 8 wherein the jewelry comprises two separate units, each for attachment to an ear.

11. The process according to claim 8 wherein the gemstones are selected from the group consisting of diamonds, emeralds, sapphires, zircons and rubies.

12. The process according to claim 8 wherein the first and second gemstones are a pair of diamonds.

13. The process according to claim 8 wherein the at least four physical properties and their match tolerances are selected from the group consisting of carat weight (plus or minus 6% of average), color (one grade or less), clarity (one grade or less, same category), table % (plus or minus 6% of average), crown height (plus or minus 10% of average), average diameter (plus or minus 5%), girdle (both polished or bruted), culet (2 grades or less), finish (2 grades or less), and fluorescence (2 grades or less).

14. Jewelry comprising at least two matched gemstones, the gemstones being held in settings and the gemstones being certified in a single certificate that the gemstones constitute a matched set.

15. The jewelry according to claim 14 wherein the matched set has values for at least four physical properties, the values lying within match tolerances of each of at least four physical properties.

16. The jewelry according to claim 14 wherein the at least two matched gemstones are selected from the group consisting of diamonds, emeralds, sapphires, zircons and rubies.

17. The jewelry according to claim 16 wherein the at least two matched gemstones are diamonds.

18. The jewelry according to claim 15 wherein the at least four physical properties and their match tolerances are selected from the group consisting of carat weight (plus or minus 6% of average), color (one grade or less), clarity (one grade or less, same category), table % (plus or minus 6% of average), crown height (plus or minus 10% of average), average diameter (plus or minus 5%), girdle (both polished or bruted), culet (2 grades or less), finish (2 grades or less), and fluorescence (2 grades or less).

19. The jewelry according to claim 14 wherein the at least two matched gemstones are three gemstones in number.

20. The jewelry according to claim 14 wherein the certificate has photos of the at least two matched gemstones and sets forth values for at least four physical properties.
